(19) United States
(12) Patent Application Publication
(10) Pub. No.: US 2024/0278326 A1
(43) Pub. Date: Aug. 22, 2024

(54) METHOD OF POWDER BED-BASED ADDITIVE MANUFACTURING OF AN INTRICATE STRUCTURE WITH PREDETERMINED POROSITY AND POROUS FUNCTIONAL STRUCTURE

(71) Applicant: Siemens Energy Global GmbH & Co. KG, Munich, Bayern (DE)

(72) Inventors: Johannes Albert, Berlin (DE); Ole Geisen, Berlin (DE)

(73) Assignee: Siemens Energy Global GmbH & Co. KG, Munich, Bayern (DE)

(21) Appl. No.: 18/568,176

(22) PCT Filed: Jun. 10, 2022
(86) PCT No.: PCT/EP2022/065809

§ 371 Date: Dec. 7, 2023

(30) Foreign Application Priority Data
Jun. 14, 2021 (DE) 10 2021 206 000.5

(51) Int. Cl. B22F 10/366; B22F 3/11; B22F 10/28; B22F 10/38; B33Y 10/00; B33Y 80/00

(52) U.S. Cl. CPC B22F 10/366; B22F 3/1103; B22F 10/28; B22F 10/38; B22F 2999/00; B33Y 10/00; B33Y 80/00

(57) ABSTRACT

A method of powder bed-based additive manufacturing of an intricate structure is specified, wherein the structure has a predetermined porosity, wherein a multitude of parallel irradiation vectors is chosen for selective irradiation of a powder layer for the production of the structure, wherein melt pathways generated by the parallel irradiation vectors are free of overlaps and wherein the parallel irradiation vectors also run parallel to the structure to be formed thereby. Additionally specified are a computer program product and a corresponding porous functional structure.

### CROSS REFERENCE TO RELATED APPLICATIONS

This application is the U.S. National Stage of International Application No. PCT/EP2022/065809 filed 10 Jun. 2022, and claims the benefit thereof, which is incorporated by reference herein in its entirety. The International Application claims the benefit of German Application No. DE 10 2021 206 000.5 filed 14 Jun. 2021.

### FIELD OF INVENTION

The present invention relates to a method for powder bed-based, additive manufacturing of an intricate structure with a predetermined porosity. Furthermore, a corresponding irradiation strategy or associated manufacturing instructions, a corresponding computer program product, and a functional structure manufactured by the method described are specified.

The structure is provided for example for use in coolable components or components to be cooled, such as, for example, turbine parts exposed to hot gas, as a membrane, in particular a mixed-conducting membrane or filter membrane, and/or as a functional medium in a heat exchanger or heat transfer apparatuses. Alternatively, the structure can be some other component part.

### BACKGROUND OF INVENTION

Such structures or component parts are the subject of constant improvement in order to increase their efficiency and functionality, in particular. Hot gas parts of gas turbines, for example, are being developed to be resistant to ever higher use temperatures. Corresponding metallic materials for this purpose have to be cooled ever more reliably and with ever greater performance.

On account of technological further development, generative or additive manufacturing is also increasingly becoming of interest for the series production of the component parts mentioned above, such as, for example, turbine components or other specialized intricate or thin-walled component parts, such as membranes.

Additive manufacturing (AM) methods, colloquially also referred to as “3D printing”, comprise as powder bed methods, for example, selective laser melting (SLM) or selective laser sintering (SLS), or electron beam melting (EBM).

A method for additive manufacturing of a three-dimensional object is known from WO 2014/202352 A1, for example.

As is known, additive manufacturing methods have proved to be particularly advantageous for complex or intricately designed component parts, for example labyrinthine structures, cooling structures and/or lightweight structures. In particular, additive manufacturing is advantageous by virtue of a particularly short chain of processing steps since a production or manufacturing step for a component part can be carried out largely on the basis of a corresponding CAD file and the selection of corresponding manufacturing or irradiation parameters.

The manufacture of intricate structures or membranes by means of the powder bed-based methods described (also referred to as PBF, standing for “powder bed fusion”) advantageously makes it possible to implement new geometries, concepts, solutions and/or designs which can reduce the manufacturing costs or the build and throughput times, optimize the manufacturing process and improve for example a functional design or durability of the components.

Components manufactured in a conventional manner, for example by casting technology, subtractively or in some other way, are distinctly inferior to the additive manufacturing route, for example with regard to their shaping freedom and also in regard to the required throughput time and the high costs associated therewith and also the production engineering outlay. As a result of the powder bed process, however, thermal stresses may inherently arise in the component structure, and need to be relaxed during manufacturing by an additive route. Furthermore, a process outlay, also encompassing particularly complex data processing for process preparation in the case of intricate structures, must not be underestimated.

### SUMMARY OF INVENTION

It is therefore an object of the present invention to specify an improved additive manufacturing method already by virtue of improved process preparation by virtue of the definition of an irradiation strategy or corresponding manufacturing instructions, for example by way of CAM (“computer-aided manufacturing”), where in particular the construction of complex, intricate and/or porous structures can be improved. In particular, the approaches described are intended to make it possible to keep down the preparatory process outlay (in terms of data technology) and to increase the shaping freedom already by virtue of the proposed irradiation strategy (computer-implemented).

This object is achieved by means of the subject matter of the independent patent claims. The dependent patent claims relate to advantageous embodiments.

One aspect of the present invention relates to a method for powder bed-based additive manufacturing of an intricate structure having a predetermined porosity, wherein a plurality of parallel irradiation vectors are chosen for selective irradiation of a powder layer for the manufacture of the structure, wherein melt pathways (which then expediently produce a corresponding structure) produced by the parallel irradiation vectors are free of overlaps, i.e. preferably do not touch or overlap one another, and wherein the parallel irradiation vectors furthermore run parallel to the structure to be formed thereby.

In the present case, in relation to the structure described, the term “intricate” preferably means that the structure is embodied as delicate and/or thin-walled, where each wall or each section is preferably provided with the predetermined porosity.

During operation of the structure in a component part, the defined porosity is preferably intended to serve for functional permeation by a medium or gas. By virtue of the predetermined porosity properties of the structure, the structure can advantageously be equipped with tailored functional properties, e.g. a cooling capacity, heat transfer or catalytic properties or permeation properties.

In this regard, one aspect of the present invention can already be seen in the provision of an irradiation strategy, in particular an irradiation pattern for the described method as a manufacturing stipulation, preferably by way of manufacturing preparation by means of CAM, where the irradiation strategy for the powder layers can be defined in a computer-implemented manner by means of a laser beam or electron beam.

By virtue of a concluding contour irradiation, for example, the structure built in this way can obtain dimensionally stable properties and accordingly be used functionally in a component part.

In particular, what can advantageously be achieved by means of the solution described is that complex and arbitrary or arbitrarily or irregularly shaped component part regions, such as walls or the like, are manufactured in a simple manner. At the same time, the complexity of a strictly ordered gridlike irradiation or production can advantageously be avoided. In other words, the structure or a component part containing the structure can be provided regionally with a degree of randomness in terms of its porosity or permeability. Moreover, the corresponding structure can be manufactured close to the contour by virtue of the definition or selection and implementation of the parallel irradiation vectors, since the irradiation vectors chosen all run parallel to the contour of the structure. As a result, advantageously, it is furthermore possible to avoid difficulties in the additive construction of particularly thin or delicate structures, in particular to improve thermal management and to reduce the risk of overheating resulting in distortions and shape deviations.

In one embodiment, a course of the irradiation vectors or the course of the structure to be formed thereby is bent or curved - for example as viewed in a plan view of the corresponding layer plane.

In one embodiment, the course of the irradiation vectors or the course of the structure to be formed thereby is wavy.

In one embodiment, the course of the irradiation vectors or the course of the structure to be formed thereby corresponds to an arbitrary, random or irregular shape, such as a kind of freehand shape, for example.

By means of these embodiments, the advantages according to the invention—as described above—can be implemented particularly expediently and efficiently.

In one embodiment, for example, three, four, five, six, eight or ten irradiation vectors running parallel are chosen layer by layer for the structure. Advantageously, the structures produced by the vectors can then be realized—by way of corresponding melt pathways. Within the meaning of the present invention, preferably each of the parallel-running walls thus manufactured in the finished structure has the predetermined porosity.

In one embodiment, an irradiation strategy for manufacturing a layer of the structure has a plurality of stages. In other words, preferably further irradiation vectors can be chosen for the solidification of each layer for the component part, as will be described below.

In one embodiment, perpendicular (further) irradiation vectors are chosen layer by layer for the structure—preferably subsequently to the irradiation of the parallel vectors—, which perpendicular irradiation vectors cross the parallel irradiation vectors and structurally connect a welding pathway and/or structure produced thereby, i.e. by the parallel vectors.

In one embodiment, the perpendicular irradiation vectors are normal vectors which extend perpendicularly or orthogonally from an outer vector on a first side of the parallel irradiation vectors (at a first side) away from the first side and in the direction of a second, opposite side of the parallel irradiation vectors. The aforementioned sides (first and second sides) preferably relate to an edge of the irradiation pattern formed by the parallel irradiation vectors, from which the structure then emerges by way of the selective beam control during manufacturing.

These additionally chosen perpendicular or crossing irradiation vectors also support the advantageous effect according to the invention of producing a tailored or advantageous permeability of the structure close to the contour, or produce a degree of advantageous “randomness” in the permeation properties of the structure.

In one embodiment, the perpendicular irradiation vectors are truncated if a distance between adjacent vectors from among these vectors falls below a predetermined value.

In one embodiment, the perpendicular irradiation vectors are inserted if a distance between adjacent vectors from among these vectors exceeds a predetermined value.

In other words, the perpendicular irradiation vectors can be adapted in terms of their length or their course in the context of process or manufacturing preparation, for example via CAM, in order to adjust the porosity or the permeability properties of the structure and/or, if appropriate, to avoid local overheating (“hot spots”) in the thin structure.

In one embodiment, in a layer following the irradiation of the aforementioned powder layer, for the structure, likewise firstly parallel irradiation vectors are chosen and then perpendicular irradiation vectors which connect structures produced by said parallel irradiation vectors and which extend perpendicularly from an outer vector (on the second side) of the parallel irradiation vectors away from the second side and in the direction of the first side of the parallel irradiation vectors.

In one embodiment, the parallel irradiation vectors for the following layer, in the layer plane, are chosen or arranged to be offset with respect to the parallel irradiation vectors of the powder layer. This offset advantageously makes it possible to achieve an additional deviation from a strict layer-by-layer ordering or arrangement of the irradiation vectors, which brings about a degree of “randomness” of the porosity properties and can thus improve throughflow properties or functional properties of the structure.

In one embodiment, the perpendicular irradiation vectors are interrupted and in each case connect only structures produced by two adjacent parallel irradiation vectors. This advantageously makes it possible furthermore to fabricate pores or interspaces in the structure and also to adjust and/or improve the micro- and macroscopic permeability properties of the structure.

In one embodiment, the perpendicular irradiation vectors define a pulsed irradiation operating mode. As is known, such an irradiation operating mode can be implemented by pulsation or pulse modulation of an energy beam, for example a laser beam or electron beam, by way of CAM, or manually.

In one embodiment, a pulse spacing corresponds to a spatial distance between the parallel irradiation vectors.

A further aspect of the present invention relates to a computer program product, comprising instructions which, when the program is executed by a computer or “build processor”, for example for the purpose of controlling the irradiation in an additive manufacturing installation, cause said computer or processor to choose the irradiation vectors in accordance with the method described.

A CAD file or a computer program product can be provided or be present for example as a (volatile or nonvolatile) storage or reproduction medium, such as e.g. a memory card, a USB stick, a CD-ROM or DVD, or else in the form of a downloadable file from a server and/or in a network. It can furthermore be provided e.g. in a wireless communication network by way of the transmission of a corresponding file with the computer program (product).

A computer program product can in turn include program code, machine code or numerical control instructions, such as G-code and/or other executable program instructions in general.

In one embodiment, the computer program product relates to manufacturing instructions according to which an additive manufacturing installation is controlled, for example using CAM means by way of a corresponding computer program, for manufacturing the component part.

The computer program product can furthermore contain geometry data and/or design data in a data set or data format, such as a 3D format or as CAD data, or comprise a program or program code for providing these data.

A further aspect of the present invention relates to a porous functional structure, comprising a network, braiding or a predetermined arrangement with a plurality of, for example inner and/or outer, intricate structures or walls manufactured according to the present method. As soon as the resolution falls below a certain resolution limit during the manufacture of such intricate structures, said structure can no longer be manufactured by conventional approaches. This should already be applicable starting from pore sizes below a few millimeters.

In one embodiment, wall regions of the functional structure are designed for example as curved gyroid surfaces or minimal surfaces, via which for example two different fluids - while maintaining the predetermined porosity properties—can be guided.

In one embodiment, the fusion structure is configured as part of a heat exchanger or heat transfer apparatus for heat transfer or as a fluid-permeable membrane.

In one embodiment, the functional structure is a filter membrane or comprises such a membrane.

In one embodiment, the functional structure comprises a membrane, for example a mixed-conducting (electron- and ion-conducting) membrane, wherein the functional structure or the intricate structure is provided with an electrolytic or catalytic ceramic coating, such as a coating of strontium titanate, titanium oxide, cerium oxide or lithium iron phosphate.

Embodiments, features and/or advantages relating in the present case to the method or respectively the computer program (product) may furthermore relate to the functional structure directly or a component part comprising said functional structure, and vice versa.

The expression “and/or” used here, if it is used in a series of two or more elements, means that each of the elements mentioned may be used by itself, or any combination of two or more of the elements mentioned may be used.

Further details of the invention are described below with reference to the figures.

### BRIEF DESCRIPTION OF THE DRAWINGS

FIG. 1 shows a schematic basic illustration of a powder bed-based additive manufacturing method.

FIG. 2 indicates, on the basis of four partial illustrations, a), b), c) and d), in each case different parts or steps of an irradiation strategy for the additive manufacture of an intricate component part structure.

FIG. 3 indicates, in a manner similar to FIG. 2, details of the proposed irradiation strategy.

FIG. 4 indicates, in a manner similar to FIG. 2, further details of the proposed irradiation strategy.

FIG. 5 indicates, in a manner similar to FIG. 2, even further details of the proposed irradiation strategy.

FIG. 6 shows a component part with an intricate functional structure that was manufactured by the proposed approaches.

### DETAILED DESCRIPTION OF INVENTION

In the exemplary embodiments and figures, identical or identically acting elements may each be provided with the same reference signs. The illustrated elements and their size relationships among one another should not be regarded as true to scale, in principle, rather individual elements may be illustrated with exaggerated thickness or size dimensions in order to enable better illustration and/or in order to afford a better understanding.

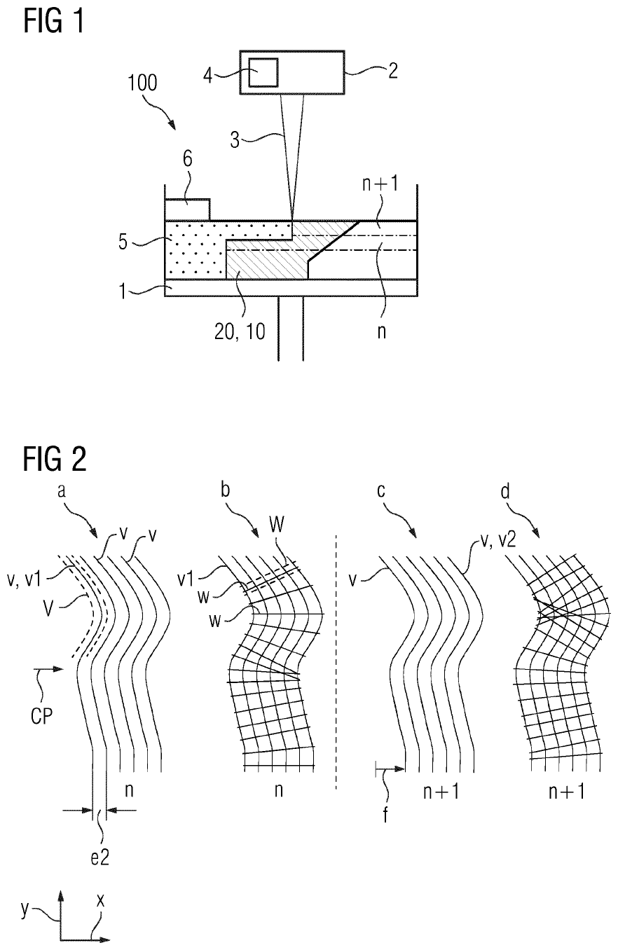

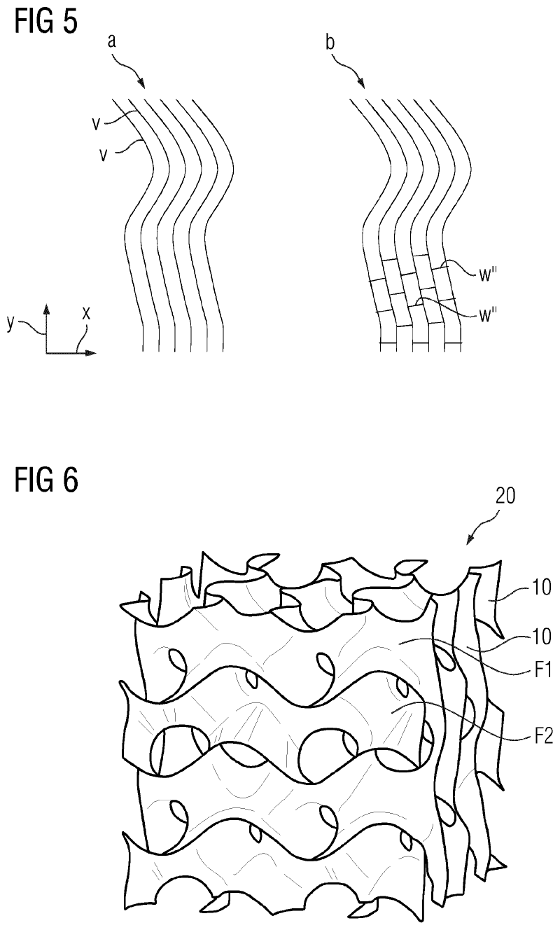

FIG. 1 indicates steps of the powder bed-based manufacture of a structure 10, by way of reference to a manufacturing installation 100 illustrated in a simplified manner. The structure 10 is preferably a thin-walled or intricate structure, for example as part of a component part or of a functional part thereof. As is described with reference to FIG. 6 further below, the structure or the component part can concern a filter membrane, or for example parts of a heat transfer apparatus.

The manufacturing installation 100 can be embodied as an LPBF (“laser powder bed fusion”) installation and for the additive construction of component parts or components from a powder bed, in particular for selective laser melting. The installation 100 can specifically also concern an installation for selective laser sintering or electron beam melting.

Accordingly, the installation has a build platform 1. On the build platform 1, a component part structure 10 to be produced by additive manufacturing is manufactured layer by layer from a powder bed 5. The latter is then accordingly formed by a powder in a build space. In accordance with this embodiment, the powder is preferably distributed by means of a squeegee 6 layer by layer on the build platform 1 or a manufacturing surface situated thereabove.

After the application of each layer L of powder with a predetermined layer thickness, in accordance with the predefined geometry of the component part 10, regions of the layers n are selectively melted with an energy beam 3, for example a laser or electron beam, from an irradiation device 2 and are subsequently solidified. After each layer, the build platform 1 is then preferably lowered by an amount corresponding to the layer thickness (usually only between 20 μm and 40 μm).

In accordance with an alternative embodiment, however, the installation may also denote a device or a corresponding “3D printer” for so-called fused deposition modeling (FDM, also known as FFF standing for “fused filament fabrication”) or laser deposition welding, for example. In accordance with this embodiment, the structure 10 is preferably likewise formed layer by layer by means of selective material application, in which case, however, a starting material can be extruded through a nozzle (cf. likewise reference sign 2) and a material application can thus be attained.

The geometry of the component part 10 is usually defined by a CAD (“computer-aided design”) file in both cases. After such a file has been read into the manufacturing installation 100, the process then requires firstly the definition of a suitable irradiation strategy for example by CAM (“computer-aided manufacturing”) means, as a result of which the component part geometry is also divided into the individual layers n. This can be carried out or implemented by a corresponding (build) processor 4 by way of a computer program.

The structure 10 or the component part 20 is preferably a coolable component—to have throughflow during operation—of the hot gas path of a turbomachine, such as a turbine blade, a heat shield component of a combustion chamber and/or a resonator component or damper component. Alternatively, the structure 10 can be a functional component part for the permeation of a gas, for example some other component part with a high thermal loading capacity, a heat transfer structure or a membrane structure, such as a mixed-conducting membrane or a filter membrane.

In order to implement manufacturing instructions for the construction of the component part (see below), for example proceeding from a predefined CAD geometry of the component part, the abovementioned build processor 4 or a corresponding controller is provided, which for example can be programmed with corresponding CAM information or manufacturing instructions and/or can accordingly cause the irradiation device 2 to build the structure 10 layer by layer in accordance with the manufacturing instructions described further below.

The build processor circuit 4 preferably functions as an interface between the software that prepares the actual build process and the corresponding hardware of the manufacturing installation 100. For this purpose, the build processor can be configured for example to execute a computer program with corresponding manufacturing instructions.

The present invention or the irradiation pattern chosen according to the present invention can already be implemented by the choice of corresponding irradiation vectors (process-preparatorily) by way of a computer program or computer program product CP, wherein the computer program expediently contains corresponding instructions which, when the program is executed by a computer, for example for the purpose of controlling the irradiation in an additive manufacturing installation 100, cause said computer to choose the irradiation vectors in accordance with the method described.

FIG. 2 indicates, on the basis of four partial illustrations, different steps when choosing irradiation vectors of a powder layer for the manufacture of the intricate structure or the corresponding physical manufacturing measures themselves.

Accordingly, an irradiation strategy for manufacturing a layer of the structure 10 expediently has a plurality of stages.

The left-hand partial illustration a) shows a partial irradiation pattern consisting of a plurality of parallel irradiation vectors v.

This pattern or corresponding manufacturing instructions—like further patterns presented in the present case—can also already be implemented or defined in part or in full by CAM means in the form of a computer program product.

FIG. 1a) shows that the course of the irradiation vectors v or the course of the structure 10 to be formed thereby is wavy. The dashed boundary (only partly illustrated) of a first or first-side irradiation vector v1 (cf. on the left in the illustration) is intended to indicate a corresponding melt pathway V or solidified structure 10.

Preferably, the course of the irradiation vectors v or the course of the structure 10 to be formed thereby corresponds to an arbitrary, random or irregular shape. Accordingly, the course of the irradiation vectors v can be a kind of freehand shape or an arbitrary or arbitrarily definable contour or shape.

Merely by way of example, the present illustrations show six irradiation vectors v running parallel layer by layer for the structure 10, which irradiation vectors form a corresponding manufacturing instruction for the physical manufacture of the structure. In a departure therefrom and without restricting the generality, for example three, four, five, eight or ten irradiation vectors v running parallel can alternatively be chosen.

Finally, the proposed method according to the invention is a method for powder bed-based additive manufacturing of an intricate structure 10 having a predetermined porosity, wherein a plurality of parallel irradiation vectors v are chosen for selective irradiation of a powder layer n for the manufacture of the structure 10, wherein melt pathways V produced by said parallel irradiation vectors are free of overlaps and wherein the parallel irradiation vectors v furthermore run parallel to the structure 10 to be formed thereby.

The partial illustration b) in FIG. 1 indicates a further step for the irradiation of each layer for the structure 10. In accordance with this step, (further) perpendicular irradiation vectors w are chosen layer by layer for the structure, which perpendicular irradiation vectors cross the parallel irradiation vectors v and structurally connect a structure 10 produced by these vectors. Analogously to the partial illustration a), the reference sign W is intended to indicate a melt pathway produced by way of the irradiation.

Although a layer for the corresponding component part structure can also be formed just by way of the parallel vectors v, the solidified material for a layer n obtains a sufficient structural cohesion or corresponding dimensional stability particularly by way of the additionally chosen or scanned perpendicular irradiation vectors w.

Proceeding from a left edge (cf. first side) of the pattern shown, the perpendicular

irradiation vectors w constitute normal vectors which extend perpendicularly from the outer vector v1 of the parallel irradiation vectors v away from this first side and in the direction of a second, opposite side of the parallel irradiation vectors v.

The partial illustrations c) and d) show the situation of a pattern or a stipulation for the irradiation of a layer n+1 following said powder layer n (cf. likewise FIG. 1) for the structure 10, wherein likewise firstly parallel irradiation vectors v are chosen (cf. partial illustration c)) and then perpendicular irradiation vectors w (cf. partial illustration d)) which connect structures 10 produced by said parallel irradiation vectors and which extend perpendicularly from an outer vector v2 on the second side of the parallel irradiation vectors v away from this second side and in the direction of the first side of the parallel irradiation vectors v.

The arrow f shown at the bottom left in the partial illustration c) is intended to indicate that the parallel irradiation vectors v for the following layer n+1, in the layer plane, can be chosen to be offset with respect to the parallel irradiation vectors v of the powder layer n in order to realize further advantages according to the invention, such as the production of a desired, tailored, but preferably not completely homogeneous or isotropic porosity.

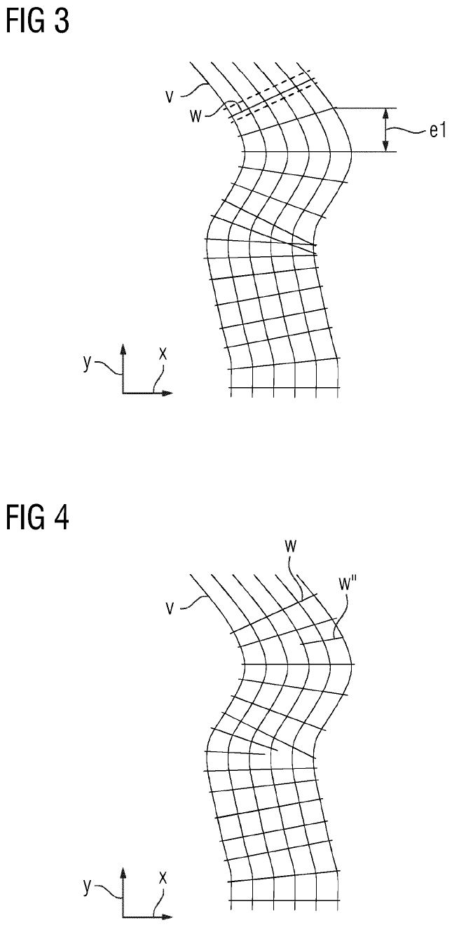

FIG. 3 shows in greater detail how the distance between the vectors w extending perpendicularly from left to right, by way of example, behaves depending on the course of the wavy vectors v. As indicated at the top with the aid of the reference sign e1, the distance may increase to an undesired extent or exceed an upper limit in this case. Offset therefrom, further below in the irradiation pattern, a narrowing or convergence of perpendicularly running vectors w may nevertheless occur, the distance falling below a minimum distance, for example, which may lead in particular to local overheating and structural defects. In other words, bent outer contours may be accompanied by the occurrence of superimpositions or larger distances between the melt pathways of the vectors w.

A solution to this problem as afforded according to the invention becomes clear from the illustration in FIG. 4, wherein the perpendicular irradiation vectors w, w′ are adapted, i.e. truncated or shortened, or in some instances newly inserted, if a distance e1 between adjacent vectors from among these vectors w falls below or, respectively, exceeds a predetermined value. In other words, the abovementioned problem is solved in the present invention by means of the adaptation of the critical vectors, or the insertion of vectors.

A further embodiment of solutions according to the invention is shown with reference to FIG. 5, where the partial illustration a) again corresponds (analogously) to the first partial illustration in FIG. 2.

The partial illustration b), in contrast to that in FIG. 2, shows that here perpendicular irradiation vectors w″ are chosen which are interrupted and in cach case connect only structures 10 produced by two adjacent parallel irradiation vectors v. As a result, it is likewise possible to produce layer by layer tailored properties of the intricate structure and/or to fabricate the structure 10 in any desired shape.

In terms of process engineering, an irradiation can thus be defined particularly advantageously by a pulsed irradiation operating mode for the vectors w, wherein a pulse spacing e2 (cf. FIG. 2) corresponds to a spatial distance between the parallel irradiation vectors v. The parallel irradiation vectors v shown can then be spaced apart from one another for example over a length of 100 μm to 1 mm, for example 500 μm.

FIG. 6 shows a specific embodiment of the component part 20 or of a functional structure comprised by this component part 20. The component part or the functional structure 20 discernibly comprises a network or braiding with a plurality of intricate structures 10, preferably produced according to the method described.

The functional structure 20 can be configured for example as part of a heat exchanger for heat transfer.

In an alternative embodiment, the functional structure or the component part can be a filter membrane.

In particular, FIG. 6 shows that the functional structure 20 is designed with thin walls as gyroid surface or gyroid body, by way of which the e.g. two different fluids F1 and F2 can be guided. The aforementioned fluids can be for example cooling fluids or other gases or liquids, for example for heat transfer or for improving or supporting physical, chemical, electrochemical, catalytic or electrolytic functions. In particular, the shown gyroid surface shaped by the structure relates to a triply periodic minimal surface with the two permeation domains guiding the corresponding fluid.

In yet another embodiment, the functional structure 20 can relate to a mixed-conducting membrane, wherein the functional region is provided with an electrolytic or catalytic ceramic coating, such as a coating of strontium titanate, titanium oxide, cerium oxide or lithium iron phosphate. Such component parts may be required and/or advantageous in particular in chemical “cracking” processes, such as olefin production possibly with appropriate decoupling or sequestration of hydrogen.

1.-15. (canceled)

16. A method for powder bed-based additive manufacturing of an intricate structure having a predetermined porosity, comprising:
choosing a plurality of parallel irradiation vectors (v) for selective irradiation of a powder layer (n) for the manufacture of the structure,
producing melt pathways (V) by the parallel irradiation vectors (v) which are free of overlaps, wherein the parallel irradiation vectors (v) run parallel to the structure to be formed thereby,
wherein an irradiation strategy for manufacturing a layer (n, n+1) of the structure has a plurality of stages, and
wherein perpendicular irradiation vectors (w) are chosen layer by layer for the structure, which perpendicular irradiation vectors cross the parallel irradiation vectors (v) and structurally connect a structure produced thereby.

17. The method as claimed in claim 16,
wherein the course of the irradiation vectors (v) or the course of the structure to be formed thereby is wavy.

18. The method as claimed in claim 16,
wherein the course of the irradiation vectors (v) or the course of the structure to be formed thereby corresponds to an arbitrary, random or irregular shape.

19. The method as claimed in claim 16,
wherein three, four, five, six, eight or ten irradiation vectors (v) running parallel are chosen layer by layer for the structure.

20. The method as claimed in claim 16,
wherein the perpendicular irradiation vectors (w) are normal vectors which extend perpendicularly from an outer vector (v1) on a first side of the parallel irradiation vectors (v) away from this first side and in the direction of a second, opposite side of the parallel irradiation vectors (v).

21. The method as claimed in claim 16,
wherein the perpendicular irradiation vectors (w, w′) are truncated or inserted if a distance (e1) between adjacent vectors from among these vectors (w) falls below or, respectively, exceeds a predetermined value.

22. The method as claimed in claim 16,
wherein in a layer (n+1) following the irradiation of the powder layer, for the structure, likewise firstly parallel irradiation vectors (v) are chosen and then perpendicular irradiation vectors which connect structures produced by said parallel irradiation vectors and which extend perpendicularly from an outer vector (v2) on the second side of the parallel irradiation vectors (v) away from this second side and in the direction of the first side of the parallel irradiation vectors (v).

23. The method as claimed in claim 22,
wherein the parallel irradiation vectors (v) for the following layer (n+1), in the layer plane (x, y), are chosen to be offset (f) with respect to the parallel irradiation vectors (v) of the powder layer (n).

24. The method as claimed in claim 16,
wherein the perpendicular irradiation vectors (w″) are interrupted and in each case connect only structures produced by two adjacent parallel irradiation vectors (v).

25. The method as claimed in claim 24,
wherein the perpendicular irradiation vectors (w) define a pulsed irradiation operating mode and a pulse spacing (e2) corresponds to a spatial distance between the parallel irradiation vectors (v).

26. A computer program product (CP) stored on a non-transitory computer readable medium, comprising
instructions stored thereon which, when executed by a computer, for the purpose of controlling the irradiation in an additive manufacturing installation, cause said computer to implement the method as claimed in claim 16.

27. A porous functional structure, comprising:
a network with a plurality of intricate structures manufactured according to the method as claimed in claim 16.

28. The porous functional structure as claimed in claim 27,
which is configured as part of a heat exchanger for heat transfer or as a fluid-permeable membrane.

29. The method as claimed in claim 16,
wherein the method is computer-implemented.

30. The method as claimed in claim 16, further comprising:
controlling the irradiation in an additive manufacturing installation based on the irradiation strategy.

31. The method as claimed in claim 30, further comprising:
additively manufacturing the intricate structure.
